(19) United States
(12) Patent Application Publication
(10) Pub. No.: US 2019/0230209 A1
(43) Pub. Date: Jul. 25, 2019

(54) Mobile Terminal

(71) Applicants: CHENGDU BOE OPTOELECTRONICS TECHNOLOGY CO., LTD., Chengdu (CN); BOE TECHNOLOGY GROUP CO., LTD., Beijing (CN)

(72) Inventors: Yuanjie XU, Beijing (CN); Shan GAO, Beijing (CN); Pengcheng ZANG, Beijing (CN); Ting LI, Beijing (CN); Zhonglin CAO, Beijing (CN); Jing HE, Beijing (CN); Wei GUO, Beijing (CN); Shiqi CHEN, Beijing (CN)

(21) Appl. No.: 16/239,830

(22) Filed: Jan. 4, 2019

(30) Foreign Application Priority Data
Jan. 24, 2018 (CN) 201810069714.6

(51) Int. Cl. H04M 1/725; H04M 1/02; G06F 3/041; G06F 3/044

(52) U.S. Cl. CPC H04M 1/7258; G06F 3/044; G06F 3/0414; H04M 1/0264

(57) ABSTRACT

The present disclosure provides a mobile terminal, including: a display screen provided at a front side of the mobile terminal; a first camera provided at a back side of the mobile terminal; and an instruction generator provided between the first camera and the display screen, and configured to generate a homepage key instruction signal in response to the first camera being pressed by a first operation mode, and the homepage key instruction signal instructs the display screen to wake up or display a home page.

### CROSS-REFERENCE TO RELATED APPLICATIONS

The present application claims the priority of Chinese Patent Application No. 201810069714.6, filed on Jan. 24, 2018 and entitled “mobile terminal”, the contents of which are incorporated herein in their entirety by reference.

### TECHNICAL FIELD

The present disclosure relates to the field of electronic device, and in particular to a mobile terminal.

### BACKGROUND

With development and progress of technology, a mobile terminal such as mobile phone, tablet computer or the like has gradually become an indispensable tool in people's life and work.

Currently, a homepage key is provided at a lower edge of a display screen of the mobile terminal, and when the mobile terminal is used, the homepage key is generally pressed to change the display screen from a black screen state to a wakeup state, or switch the display screen to display a home page.

### SUMMARY

An embodiment of the present disclosure provides a mobile terminal, including: a display screen provided at a front side of the mobile terminal; a first camera provided at a back side of the mobile terminal; and an instruction generator provided between the first camera and the display screen, and configured to generate a homepage key instruction signal in response to the first camera being pressed by a first operation mode, the homepage key instruction signal instructs the display screen to wake up or display a home page.

In some implementations, the instruction generator includes a pressure sensing component configured to generate a first pressure sensing signal as the homepage key instruction signal in response to the first camera being pressed by the first operation mode.

In some implementations, the pressure sensing component is a pressure sensor attached to a side of the first camera proximal to the display screen.

In some implementations, the pressure sensor has a dimension substantially consistent with that of the first camera.

In some implementations, the pressure sensing component is configured to generate the first pressure sensing signal as the homepage key instruction signal in response to the first camera being pressed by the first operation mode using a pressure reaching a first preset value.

In some implementations, the pressure sensing component is a pressure sensing layer provided between the display screen and the first camera, the pressure sensing layer is configured to generate the first pressure sensing signal as the homepage key instruction signal in response to the first camera being pressed by the first operation mode using a pressure reaching a first preset value.

In some implantations, the pressure sensing layer has a dimension substantially consistent with that of the display screen.

In some implementations, the pressure sensing layer is further configured to generate a preset functional instruction signal in response to the display screen being pressed.

In some implementations, the instruction generator includes a capacitive element and a detecting element, the capacitive element has a capacitance varying in response to the first camera being pressed by the first operation mode, the detecting element is configured to detect the capacitance of the capacitive element, and the instruction generator generates the homepage key instruction signal according to varying of the capacitance of the capacitive element.

In some implementations, the capacitive element includes a first electrode layer and a second electrode layer which are provided opposite to each other, and an insulation layer is provided between the first electrode layer and the second electrode layer.

In some implementations, each of the first electrode layer and the second electrode layer has a dimension substantially consistent with that of the first camera.

In some implementations, a touch control layer is provided between the display screen and the first camera, configured to generate a touch control instruction signal in response to a touch operation on the display screen, and the touch control layer includes the second electrode layer.

In some implementations, each of the first electrode layer and the second electrode layer has a dimension substantially consistent with that of the first camera, and the touch control layer has a dimension substantially consistent with that of the display screen.

In some implementations, the mobile terminal further includes: a processor configured to instruct the display screen to wake up or display the home page according to the homepage key instruction signal generated by the instruction generator.

In some implementations, the instruction generator is further configured to generate a first photographing confirmation instruction signal by delaying a preset delay time in response to the first camera being pressed by a second operation mode different from the first operation mode.

In some implementations, the mobile terminal further includes: a processor configured to instruct the mobile terminal to perform a photographing operation by using the first camera according to the first photographing confirmation instruction signal generated by the instruction generator.

In some implementations, the mobile terminal further includes a second camera provided in a non-display region of the display screen, and the instruction generator is further configured to generate a second photographing confirmation instruction signal in response to the first camera being pressed by a third operation mode different from the first operation mode.

In some implementations, the mobile terminal further includes: a processor configured to instruct the mobile terminal to perform a photographing operation by using the second camera according to the second photographing confirmation instruction signal generated by the instruction generator.

In some implementations, the first camera is provided at a position proximal to an upper edge of a back cover of the mobile terminal with respect to a center position of the back cover of the mobile terminal.

### DESCRIPTION OF DRAWINGS

FIG. 1 shows a schematic diagram of a mobile terminal being operated in an embodiment of the present disclosure;

FIG. 2 shows a block diagram of a mobile terminal in an embodiment of the present disclosure;

FIG. 3 shows a structural diagram of a mobile terminal in an embodiment of the present disclosure;

FIG. 4 shows another structural diagram of a mobile terminal in an embodiment of the present disclosure;

FIG. 5 shows further another structural diagram of a mobile terminal in an embodiment of the present disclosure;

FIG. 6 shows still another structural diagram of a mobile terminal in an embodiment of the present disclosure;

FIG. 7 shows another block diagram of a mobile terminal in an embodiment of the present disclosure;

FIG. 8 shows a structural diagram of a back cover of a mobile terminal in an embodiment of the present disclosure.

### DESCRIPTION OF EMBODIMENTS

The present disclosure will be described in detail below in conjunction with accompanying drawings and specific embodiments.

An embodiment of the present disclosure provides a mobile terminal including: a display screen provided at a front side of the mobile terminal; a first camera provided at a back side of the mobile terminal; and an instruction generator provided between the first camera and the display screen, and configured to generate a homepage key instruction signal in response to the first camera being pressed by a first operation mode, the homepage key instruction signal instructs the display screen to wake up or display a home page.

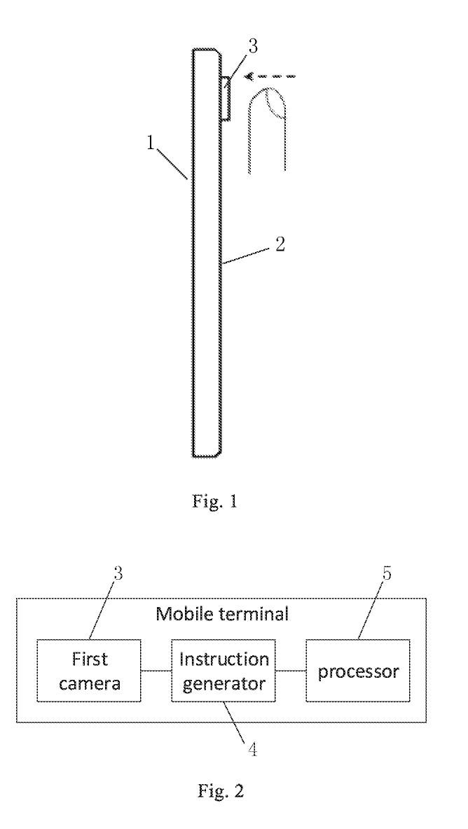

In some implementations, as shown in FIGS. 1 and 2, the mobile terminal of the present embodiment includes: a display screen 1 provided at a front side of the mobile terminal; a back cover 2 provided opposite to the display screen 1; a first camera 3 provided on the back cover 2; and an instruction generator 4 provided between the first camera 3 and the display screen 1, and configured to generate a homepage key instruction signal in response to the first camera 1 being pressed by a first operation mode, the homepage key instruction signal instructs the display screen 1 to wake up or display a home page.

It should be understood that, the first camera 3 being provided on the back cover 2 means, for example, that an outer surface of lens of the first camera 3 may be flush with an outer surface of the back cover 2, or the outer surface of lens of the first camera 3 may protrude from the outer surface of the back cover 2, and in some implementations, the first camera 3 may be embedded in an opening of the back cover 2, and the first camera 3 may further coupled to a circuit board in the mobile terminal.

In some implementations, the mobile terminal may further include: a processor 5, the processor 5 is coupled to the instruction generator 4, receives the homepage key instruction signal generated by the instruction generator 4, and instructs the display screen 1 to wake up or display the home page according to the homepage key instruction signal, that is, instructs the mobile terminal to perform an operation corresponding to the homepage key instruction signal.

In some implementations, the first camera 3 provided on the back cover 2 is a rear-facing camera of the mobile terminal, and the first camera 3 may be designed to protrude from the outer surface of the back cover 2, or may be designed not to protrude from the outer surface of the back cover 2 (i.e., the outer surface of lens of the first camera 3 may be flush with the outer surface of the back cover 2). Certainly, the first camera 3 being designed to protrude from the outer surface of the back cover 2 may facilitate a user to press the first camera 3 by a finger of a hand which is holding the mobile terminal.

By providing the instruction generator 4 between the first camera 3 and the display screen 1, when the first camera 3 is pressed by the first operation mode, the instruction generator 4 is triggered to generate the homepage key instruction signal, and the processor 5 coupled to the instruction generator 4 instructs the mobile terminal to perform the operation corresponding to the homepage key instruction signal according to the homepage key instruction signal generated by the instruction generator 4.

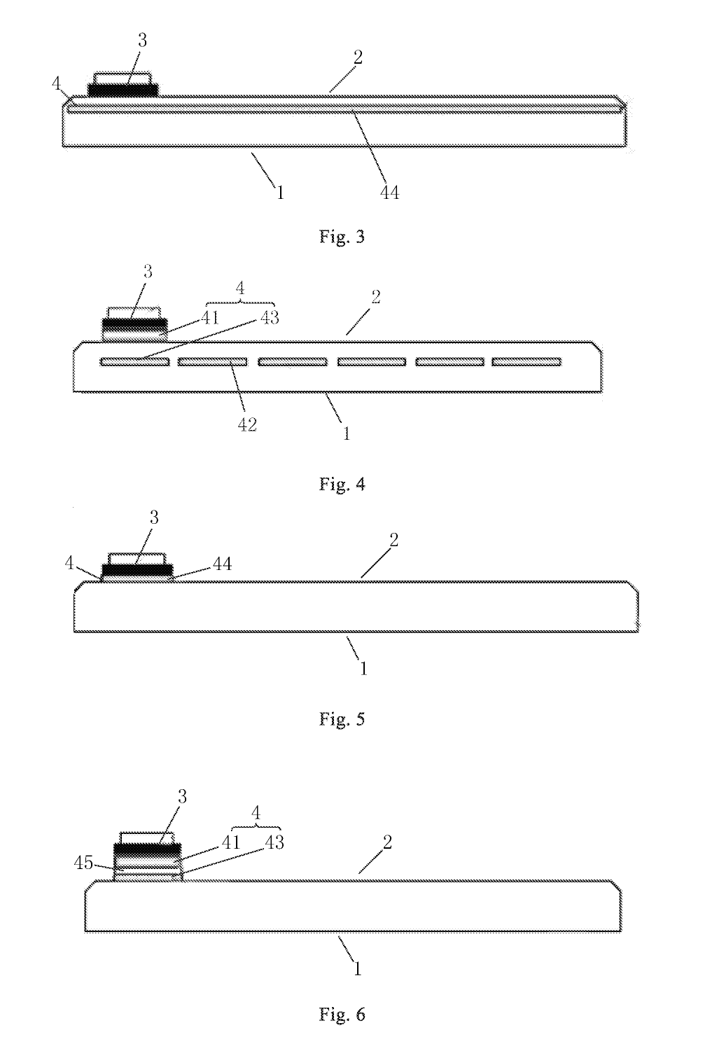

The instruction generator 4 may be designed correspondingly according to functions of the mobile terminal. For example, as shown in FIG. 3, in a case where the mobile terminal has a pressure sensing function, the instruction generator 4 may be a pressure sensing layer provided between the display screen 1 and the back cover 2, which is capable of sensing a generation and a change of a pressure, thereby generating different instruction signals according to different pressures. In a case where the display screen 1 is pressed, the pressure sensing layer can sense a pressure applied to the display screen 1, the display screen 1 may be pressed in any of various pressing modes including light pressing, heavy pressing, light and long pressing, heavy and long pressing, or the like, different pressing modes result in different pressures, thereby different instruction signals are generated. In a case where the first camera is pressed by the first operation mode, the pressure sensing layer can sense the pressure applied to the first camera 3, thus the homepage key instruction signal is generated.

In some implementations, the pressure sensing layer may have a dimension substantially consistent with that of the display screen 1, so as to facilitate to sense a pressing operation on the display screen 1. For example, the pressure sensing layer may be parallel to and completely overlapped with a display surface of the display screen 1.

Further for example, as shown in FIG. 4, in a case where the mobile terminal has a touch control function, the instruction generator 4 may include a first electrode layer 41 and a touch control layer 42 which are provided opposite to each other. The touch control layer 42 can generate a touch control instruction signal in response to a touch operation on the display screen 1. The first electrode layer 41 may be provided between the first camera 3 and the touch control layer 42. For example, the touch control layer 42 may include a plurality of touch control electrodes, the first electrode layer 41 and at least one of the touch control electrodes constitute a capacitor, and in a case where the first camera 3 is pressed by the first operation mode, a change of capacitance of the capacitor formed by the first electrode layer 41 and the at least one of the touch control electrodes occurs, a touch control chip coupled to the touch control layer 42 may sense the change of capacitance of the capacitor, and generate the homepage key instruction signal according to the change of capacitance of the capacitor. The homepage key instruction signal may be transmitted to the processor 5, and the processor 5 can instruct the mobile terminal to perform the operation corresponding to the homepage key instruction signal according to the homepage key instruction signal.

In some implementations, the first electrode layer 41 may have a dimension substantially consistent with that of the first camera 3, and the touch control layer 42 may have a dimension substantially consistent with that of the display screen 1. For example, the first electrode layer 41 may be parallel to and completely overlapped with a surface of lens of the first camera 3, and the touch control layer 42 may be parallel to and completely overlapped with the display surface of the display screen 1.

In a case where the mobile terminal has no pressure sensing function or touch control function, as shown in FIG. 5, a pressure sensor may be provided between the first camera 3 and the display screen 1 and used as the instruction generator 4. For example, the pressure sensor may have a dimension substantially consistent with that of the first camera 3, a pressure sensing surface of the pressure sensor may be parallel to and completely overlapped with the surface of lens of the first camera 3. Alternatively, as shown in FIG. 6, two electrode layers, i.e., the first electrode layer 41 and a second electrode layer 43, may be provided between the first camera 3 and the display screen 1. For example, the first electrode layer 41 and the second electrode layer 43 each may have a dimension substantially consistent with that of the first camera 3, may be parallel to and completely overlapped with the surface of lens of the first camera 3. The first electrode 41 and the second electrode 43 constitute a capacitor, and may be coupled to a touch control chip to form the instruction generator 4, so as to generate the homepage key instruction signal in response to the first camera 3 being pressed by the first operation mode. For example, the processor 5 may instruct the mobile terminal to perform the operation corresponding to the homepage key instruction signal according to the homepage key instruction signal. As required, the first operation mode may be long pressing, short pressing, double click pressing or the like.

The homepage key instruction signal may instruct the display screen 1 to wake up or display the home page, that is, wake up the display screen 1 in a black screen state or a sleep state, or switch the display screen 1 being displaying a non-home page to display the home page.

Embodiments of the present disclosure will be further described in detail below in conjunction with an operational principle of the mobile terminal.

The first camera 3 may be the rear-facing camera of the mobile terminal, and generally provided in a region of the back cover 2 proximal to an upper edge of the back cover 2, and when a user holds the mobile terminal by a hand, the index finger or the middle finger of the hand can easily touch the first camera 3, thus the user may press the first camera 3 by the first operation mode (e.g., by long pressing, double click pressing) using the index finger or the middle finger, to trigger the instruction generator 4 to generate the homepage key instruction signal. The homepage key instruction signal may be transmitted to the processor 5 so that the processor 5 can instruct the mobile terminal to perform the operation corresponding to the homepage key instruction signal.

With the first camera provided on the back cover of the mobile terminal in the embodiment of the present disclosure, the first camera is used as the rear-facing camera of the mobile terminal, the instruction generator is provided between the first camera and the display screen, and when the first camera is pressed by the first operation mode, the instruction generator generates the homepage key instruction signal in response to the first camera being pressed by the first operation mode, the homepage key instruction signal may be transmitted to the processor, so that the processor can instruct the mobile terminal to perform the operation corresponding to the homepage key instruction signal. For example, when the user holds the mobile terminal by a hand, the index finger or the middle finger of the hand can easily touch the first camera, in a case where it is required to perform the operation corresponding to the homepage key instruction signal to wake up the display screen or switch the display screen to display the home page, the user can press the first camera by the first operation mode using the index finger or the middle finger, the instruction generator can generate the homepage key instruction signal in response to the first camera being pressed by the first operation mode. A conventional mobile terminal generally includes a homepage key provided at the lower edge of the display screen, but the homepage key can be removed from the mobile terminal of the embodiment of the present disclosure, and with the mobile terminal of the embodiment of the present disclosure, by pressing the first camera of the mobile terminal by the first operation mode, the homepage key instruction signal is generated to instruct the mobile terminal to wake up the display screen or switch the display screen to display the homepage, thus no space is required for providing the homepage key, and a screen-to-body ratio of the mobile terminal can be improved.

Implementations of the instruction generator 4 will be described in detail below.

As shown in FIGS. 3 and 5, the instruction generator 4 may include a pressure sensing component 44, the pressure sensing component 44 is configured to generate a first pressure sensing signal as the homepage key instruction signal in response to the first camera 3 being pressed by the first operation mode, and the processor 5 may be configured to receive the first pressure sensing signal (i.e., the homepage key instruction signal) to instruct the mobile terminal to perform the operation corresponding to the homepage key instruction signal. When the first camera 3 is pressed, the pressure sensing component 44 can detect a corresponding pressure signal, and in a case where the pressure signal meets a preset condition, the homepage key instruction signal can be generated, and the homepage key instruction signal may be transmitted to the processor 5, so that the processor 5 can instruct the mobile terminal to perform the operation corresponding to the homepage key instruction signal. The preset condition may be set so that the homepage key instruction signal is generated only when the pressure signal detected meets the preset condition. For example, in order to avoid that the homepage key instruction signal is generated due to a user's incorrect operation or the first camera 3 being touched by accident, the generation of the homepage key instruction signal may be designed to be triggered in response to the first camera 3 being pressed by a pressure reaching a first preset value.

As shown in FIG. 5, the pressure sensing component 44 may be a pressure sensor attached to a side of the first camera 3 proximal to the display screen 1. The pressure sensor is configured to generate the first pressure sensing signal as the homepage key instruction signal in response to the first camera 3 being pressed by the first operation mode using a pressure reaching the first preset value. The processor 5 may be configured to receive the first pressure sensing signal (i.e., the homepage key instruction signal) to instruct the mobile terminal to perform the operation corresponding to the homepage key instruction signal. For example, the pressure sensor may have a dimension substantially consistent with that of the first camera 3, and the pressure sensing surface of the pressure sensor may be parallel to and completely overlapped with the surface of lens of the first camera 3.

In the embodiment, by providing the pressure sensor at the side of the first camera 3 proximal to the display screen 1, when the first camera 3 is pressed by the first operation mode using the pressure reaching the first preset value, the pressure sensor can detect the pressure applied to the first camera 3 and generate the first pressure sensing signal as the homepage key instruction signal, the homepage key instruction signal may be transmitted to the processor 5, and the processor 5 may instruct the mobile terminal to perform the operation corresponding to the homepage key instruction signal.

For example, the first operation mode may be heavy pressing, light pressing, heavy and long pressing, light and long pressing, or the like. The solution with the pressure sensor described above is relatively more suitable for the mobile terminal having no pressure sensing function, and the pressure sensor may be additionally provided and added, which results from a simple design and can be realized easily.

In addition, as shown in FIG. 3, the pressure sensing component 44 may also be a pressure sensing layer provided between the display screen 1 and the back cover 2, the pressure sensing layer may be configured to generate the first pressure sensing signal as the homepage key instruction signal in response to the first camera 3 being pressed by the first operation mode using the pressure reaching the first preset value. The homepage key instruction signal may be transmitted to the processor 5, and the processor 5 may instruct the mobile terminal to perform the operation corresponding to the homepage key instruction signal. The pressure sensing layer may also be configured to generate corresponding preset functional instructions in response to the display screen 1 being pressed. For example, the pressure sensing layer may have a dimension substantially consistent with that of the display screen 1, and the pressure sensing layer may be parallel to and completely overlapped with the display surface of the display screen 1.

By providing the pressure sensing layer in the mobile terminal, the mobile terminal has a pressure sensing function, and the pressure sensing layer can sense different pressures so that different functional instructions are generated. For example, the pressure sensing layer can sense different combinations of pressing forces and pressing durations so that different functional instructions can be generated to instruct the mobile terminal to perform different functional operations. For example, various pressing modes such as heavy pressing, light pressing, heavy and long pressing, light and long pressing, or the like may be designed for generating different functional instructions respectively. By taking the first operation mode being the heavy and long pressing as an example, when the user presses the first camera 3 by the pressure reaching the first preset value for duration reaching a first preset time, the pressure sensing layer triggers to generate the homepage key instruction signal. The homepage key instruction signal may be transmitted to the processor 5, and the processor 5 may instruct the mobile terminal to perform the operation corresponding to the homepage key instruction signal. The generation of the homepage key instruction signal being triggered by any other pressing mode such as heavy pressing, light pressing, light and long pressing or the like is similar to that triggered by the heavy and long pressing, thus will not be described in detail one by one here. The solution with the pressure sensing layer is relatively more suitable for the mobile terminal having the pressure sensing function, no pressure sensor would be added, but the mobile terminal would has more advanced and more comprehensive functions.

The first operation mode may also be any of other operation modes such as long pressing, short pressing, double click pressing or the like. For example, in a case where the first operation mode is the long pressing, the pressure sensing component 44 may be configured to generate the first pressure sensing signal as the homepage key instruction signal in response to the first camera 3 being pressed for the duration reaching the first preset time, the homepage key instruction signal may be transmitted to the processor 5, and the processor 5 may instruct the mobile terminal to perform the operation corresponding to the homepage key instruction signal. Further for example, in a case where the first operation mode is the short pressing, the pressure sensing component 44 may be configured to generate the first pressure sensing signal as the homepage key instruction signal in response to the first camera 3 being pressed for a duration less than a second preset time, the homepage key instruction signal may be transmitted to the processor 5, and the processor 5 may instruct the mobile terminal to perform the operation corresponding to the homepage key instruction signal. Still further for example, in a case where the first operation mode is the double click pressing, the pressure sensing component 44 may be configured to generate the first pressure sensing signal as the homepage key instruction signal in response to the first camera 3 being pressed two times during a third preset time, the homepage key instruction signal may be transmitted to the processor 5, and the processor 5 may instruct the mobile terminal to perform the operation corresponding to the homepage key instruction signal.

As shown in FIGS. 4 and 6, the instruction generator 4 may include a capacitive element and a detecting element. A capacitance of the capacitive element changes in response to the first camera 3 being pressed by the first operation mode. The detecting element is configured to detect the capacitance of the capacitive element, and the instruction generator 4 can generate the homepage key instruction signal according to a change of capacitance of the capacitive element detected by the detecting element. The capacitive element may include the first electrode 41 and the second electrode 43 provided opposite to each other. When the first camera 3 is pressed by the first operation mode, a change of capacitance of the capacitive element constituted by the first electrode layer 41 and the second electrode layer 43 occurs, the detecting element detects the change of capacitance of the capacitive element, and the homepage key instruction signal is generated. The homepage key instruction signal may be transmitted to the processor 5, and the processor 5 may be configured to instruct the mobile terminal to perform the operation corresponding to the homepage key instruction signal according to the homepage key instruction signal. With a capacitive touch control technology in the present embodiment, when the user presses the first camera 3 by the first operation mode using a finger, a change of capacitance of the capacitive element occurs, the detecting element detects the change of capacitance of the capacitive element and the homepage key instruction signal is correspondingly generated. The homepage key instruction signal may be transmitted to the processor 5, and the processor 5 may be configured to instruct the mobile terminal to perform the operation corresponding to the homepage key instruction signal. The first operation mode may be designed to be long pressing, shot pressing, double click pressing or the like. For example, in a case where the first operation mode is the long pressing, when the detecting element detects that a change of capacitance of the capacitive element occurs for the duration reaching the first preset time, the instruction generator 4 generates the homepage key instruction signal. Further for example, in a case where the first operation mode is the short pressing, when the detecting element detects that a change of capacitance of the capacitive element occurs for the duration less than the second preset time, and the instruction generator 4 generates the homepage key instruction signal. Still further for example, in a case where the first operation mode is the double click pressing, when the detecting element detects that the capacitance of the capacitive element changes two times during the third preset time, the instruction generator 4 generates the homepage key instruction signal.

The solution described above is suitable for the mobile terminal having no touch control function. As shown in FIG. 6, the first electrode layer 41 and the second electrode layer 43 may be provided opposite to each other at the side of the first camera 3 proximal to the display screen 1, an insulation layer 45 may be provided between the first electrode layer 41 and the second electrode layer 43, so that the first electrode layer 41 and the second electrode layer 43 constitute the capacitive element. For example, the first electrode layer 41 and the second electrode layer 43 each may have a dimension substantially consistent with that of the first camera 3, and the first electrode layer 41 and the second electrode layer 43 may be parallel to and completely overlapped with the surface of lens of the first camera 3.

In addition, the solution described above is also suitable for the mobile terminal having the touch control function. As shown in FIG. 4, the touch control layer 42 is provided between the display screen 1 and the back cover 2, and the touch control layer 42 includes the second electrode layer 43. The detecting element may be for example a touch control chip coupled to the touch control layer 42, and the touch control layer 42 may further be configured to generate a corresponding touch control signal in response to the display screen 1 being pressed, so as to instruct the mobile terminal to perform a corresponding touch response. For example, the touch control layer 42 may have a dimension substantially consistent with that of the display screen 1. The touch control layer 42 may include a plurality of touch control electrodes, and at least one of the touch control electrodes may be used as the second electrode layer 43. By providing the touch control layer 42 in the mobile terminal, the mobile terminal has the touch control function. In addition, the first electrode layer 41 is provided between the touch control layer 42 and the first camera 3, thus the second electrode layer 43 included in the touch control layer 42 and the first electrode layer 41 constitute the capacitive element, and when the first camera 3 is pressed by the first operation mode, a change of capacitance of the capacitive element occurs, the touch control chip coupled to the touch control layer 42 may sense the change of capacitance of the capacitive element, and the homepage key instruction signal is generated according to the change of capacitance of the capacitive element. The homepage key instruction signal may be transmitted to the processor 5, and the processor 5 may instruct the mobile terminal to perform the operation corresponding to the homepage key instruction signal. The first operation mode may be any of other operation modes such as long pressing, short pressing, double click pressing or the like. Similarly, the second electrode layer 43 included in the touch control layer 42 and the first electrode layer 41 each may have a dimension substantially consistent with that of the first camera 3, the touch control layer 42 may have a dimension substantially consistent with that of the display screen 1, the second electrode layer 43 included in the touch control layer 42 and the first electrode layer 41 each may be parallel to and completely overlapped with the surface of lens of the first camera 3, and the touch control layer 42 may be parallel to and completely overlapped with the display surface of the display screen 1, thereby the surface of lens of the first camera 3 may be parallel to and overlapped with the display surface of the display screen 1.

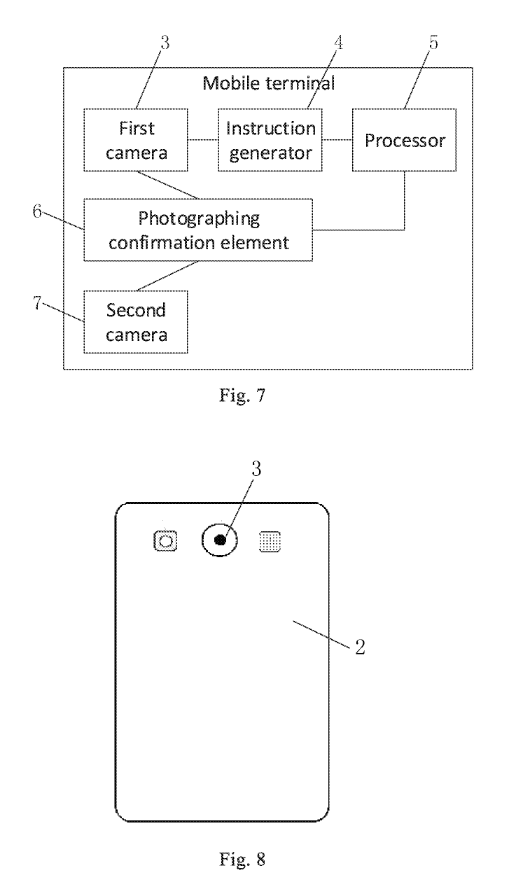

In some implementations, as shown in FIG. 7, the mobile terminal may further include a photographing confirmation element 6 coupled to the first camera 3 and the processor 5, the instruction generator 4 is further configured to generate the first photographing confirmation instruction signal by delaying a preset delay time in response to the first camera 3 being pressed by a second operation mode different from the first operation mode, the first photographing confirmation instruction signal may be transmitted to the processor 5, and the processor 5 may instruct the photographing confirmation element 6 according to the first photographing confirmation instruction signal to confirm to perform photographing by using the first camera 3. In a case where a conventional mobile terminal performs photographing, a confirmation button provided at the lower edge of the display screen 1 generally needs to be pressed. However, with the mobile terminal of the embodiment of the present disclosure, photographing is performed by pressing the first camera 3 by the second operation mode, the first camera 3 is the rear-facing camera of the mobile terminal, and when the user holds the mobile terminal by a hand, the index finger or the middle finger of the hand can easily touch the first camera 3, in a case where the first camera 3 is under a photographing mode, the instruction generator 4 can generate the first photographing confirmation instruction signal by delaying the preset delay time in response to the first camera 3 being pressed by the second operation mode, the first photographing confirmation instruction signal may be transmitted to the processor 5 so that the processor 5 can instruct the photographing confirmation element 6 according to the first photographing confirmation instruction signal to confirm to perform photographing by using the first camera 3. By providing the preset delay time, the user has a time to remove the finger from the first camera 3 and adjust a photographing angle. The second operation mode is different from the first operation mode, for example, the first operation mode may be long pressing, double click pressing, heavy pressing, heavy and long pressing or the like, and the second operation mode may be short pressing, light pressing, light and long pressing or the like.

As shown in FIG. 7, the processor 5 may be coupled to the photographing confirmation element 6 to instruct the photographing confirmation element 6 to perform photographing by using the first camera 3.

In some implementations, a second camera 7 may be provided in a non-display region of the display screen 1, the photographing confirmation element 6 is further coupled to the second camera 7, and the instruction generator 4 is further configured to, in a case where the second camera 7 is under a photographing mode, generate a second photographing confirmation instruction signal in response to the first camera 3 being pressed by a third operation mode different from the first operation mode. The second photographing confirmation instruction signal may be transmitted to the processor 5, and the processor 5 may instruct the photographing confirmation element 6 according to the second photographing confirmation instruction signal to confirm to perform photographing by using the second camera 7. The second camera 7 may be a front-facing camera of the mobile terminal, and when the user holds the mobile terminal by a hand, the second camera 7 is under the photographing mode and the first camera 3 is pressed by the third operation mode using the index finger or the middle finger of the hand, the instruction generator 4 generates the second photographing confirmation instruction signal, the second photographing confirmation instruction signal may be transmitted to the processor 5, and the processor 5 may instruct the photographing confirmation element 6 according to the second photographing confirmation instruction signal to confirm to perform photographing by using the second camera 7. The third operation mode is different from the first operation mode, but the third operation mode may be the same as the second operation mode. Certainly, the third operation mode may also be different from the second operation mode.

In some implementations, as shown in FIG. 8, the first camera 3 is provided at a position of the back cover 2 proximal to an upper edge of the back cover 2 with respect to a center position of the back cover 2. In such case, when the user holds the mobile terminal by a hand, the index finger or the middle finger of the hand can easily touch the first camera 3 to press the first camera 3.

With the first camera provided on the back cover of the mobile terminal in the embodiment of the present disclosure, the first camera may be used as the rear-facing camera of the mobile terminal, the instruction generator is provided between the first camera and the display screen, and when the first camera is pressed by the first operation mode, the instruction generator generates the homepage key instruction signal in response to the first camera being pressed by the first operation mode, the homepage key instruction signal may be transmitted to the processor, so that the processor can instruct the mobile terminal to perform the operation corresponding to the homepage key instruction signal. For example, when the user holds the mobile terminal by a hand, the index finger or the middle finger of the hand can easily touch the first camera, in a case where it is required to perform the operation corresponding to the homepage key instruction signal to wake up the display screen or switch the display screen to display the home page, the user can press the first camera by the first operation mode using the index finger or the middle finger, the instruction generator can generate the homepage key instruction signal in response to the first camera being pressed by the first operation mode. A conventional mobile terminal generally includes a homepage key provided at the lower edge of the display screen, but the homepage key can be removed from the mobile terminal of the embodiment of the present disclosure, and with the mobile terminal of the embodiment of the present disclosure, by pressing the first camera of the mobile terminal by the first operation mode, the homepage key instruction signal is generated to instruct the mobile terminal to wake up the display screen or switch the display screen to display the homepage, thus no space is required for providing the homepage key, and a screen-to-body ratio of the mobile terminal can be improved.

It should be understood that, the above embodiments and implementations are merely exemplary embodiments and implementations for explaining principle of the present disclosure, but the present disclosure is not limited thereto. Various modifications and improvements may be made by those ordinary skilled in the art within the spirit and essence of the present disclosure, these modifications and improvements fall into the protection scope of the present disclosure.

1. A mobile terminal, comprising:
a display screen provided at a front side of the mobile terminal;
a first camera provided at a back side of the mobile terminal; and
an instruction generator provided between the first camera and the display screen, and configured to generate a homepage key instruction signal in response to the first camera being pressed by a first operation mode, and the homepage key instruction signal instructs the display screen to wake up or display a home page.

2. The mobile terminal of claim 1, wherein the instruction generator comprises a pressure sensing component configured to generate a first pressure sensing signal as the homepage key instruction signal in response to the first camera being pressed by the first operation mode.

3. The mobile terminal of claim 2, wherein the pressure sensing component is a pressure sensor attached to a side of the first camera proximal to the display screen.

4. The mobile terminal of claim 3, wherein the pressure sensor has a dimension substantially consistent with that of the first camera.

5. The mobile terminal of claim 2, wherein the pressure sensing component is configured to generate the first pressure sensing signal as the homepage key instruction signal in response to the first camera being pressed by the first operation mode using a pressure reaching a first preset value.

6. The mobile terminal of claim 2, wherein the pressure sensing component is a pressure sensing layer provided between the display screen and the first camera, the pressure sensing layer is configured to generate the first pressure sensing signal as the homepage key instruction signal in response to the first camera being pressed by the first operation mode using a pressure reaching a first preset value.

7. The mobile terminal of claim 6, wherein the pressure sensing layer has a dimension substantially consistent with that of the display screen.

8. The mobile terminal of claim 7, wherein the pressure sensing layer is further configured to generate a preset functional instruction signal in response to the display screen being pressed.

9. The mobile terminal of claim 1, wherein the instruction generator comprises a capacitive element and a detecting element, the capacitive element has a capacitance varying in response to the first camera being pressed by the first operation mode, the detecting element is configured to detect the capacitance of the capacitive element, and the instruction generator generates the homepage key instruction signal according to varying of the capacitance of the capacitive element.

10. The mobile terminal of claim 9, wherein the capacitive element comprises a first electrode layer and a second electrode layer which are provided opposite to each other, and an insulation layer is provided between the first electrode layer and the second electrode layer.

11. The mobile terminal of claim 10, wherein each of the first electrode layer and the second electrode layer has a dimension substantially consistent with that of the first camera.

12. The mobile terminal of claim 10, wherein a touch control layer is provided between the display screen and the first camera, configured to generate a touch control instruction signal in response to a touch operation on the display screen, and the touch control layer comprises the second electrode layer.

13. The mobile terminal of claim 12, wherein, each of the first electrode layer and the second electrode layer has a dimension substantially consistent with that of the first camera, and the touch control layer has a dimension substantially consistent with that of the display screen.

14. The mobile terminal of claim 1, further comprising:
a processor configured to instruct the display screen to wake up or display the home page according to the homepage key instruction signal generated by the instruction generator.

15. The mobile terminal of claim 1, wherein the instruction generator is further configured to generate a first photographing confirmation instruction signal by delaying a preset delay time in response to the first camera being pressed by a second operation mode different from the first operation mode.

16. The mobile terminal of claim 15, further comprising:
a processor configured to instruct the mobile terminal to perform a photographing operation by using the first camera according to the first photographing confirmation instruction signal generated by the instruction generator.

17. The mobile terminal of claim 1, further comprising:
a second camera provided in a non-display region of the display screen, and
the instruction generator is further configured to generate a second photographing confirmation instruction signal in response to the first camera being pressed by a third operation mode different from the first operation mode.

18. The mobile terminal of claim 17, further comprising:
a processor configured to instruct the mobile terminal to perform a photographing operation by using the second camera according to the second photographing confirmation instruction signal generated by the instruction generator.

19. The mobile terminal of claim 1, wherein the first camera is provided at a position proximal to an upper edge of a back cover of the mobile terminal with respect to a center position of the back cover of the mobile terminal.
